(19) United States
(12) Patent Application Publication
(10) Pub. No.: US 2012/0292071 A1
(43) Pub. Date: Nov. 22, 2012

(54) AIR CYLINDER UNIT AND PNEUMATIC TOOL HAVING THE SAME

(75) Inventors: San-Yih Su, Taichung (TW); Cheng-Wei LAI, Taichung (TW); Chiang HWA, Taichung (TW); Chin-Cheng LI, Taichung (TW)

(73) Assignee: BASSO INDUSTRY CORP., Taichung (TW)

(21) Appl. No.: 13/474,340

(22) Filed: May 17, 2012

(30) Foreign Application Priority Data
May 18, 2011 (TW) 100117366

(51) Int. Cl. F15B 13/00

(52) U.S. Cl. 173/218

(57) ABSTRACT

An pneumatic tool includes a front section, a rear section connected to and disposed behind the front section, a driving unit, and an air cylinder unit. The rear section includes a main body, a handle connected to the main body and adjacent to the front section, and an intake passage in fluid communication with the outside. The air cylinder unit includes a first cylinder mounted within the rear section, a second cylinder connected to the first cylinder, an extension portion extending into the handle, and an inclined intake channel having an inlet in fluid communication with intake passage, and an outlet in fluid communication with the first cylinder. The rotor unit is mounted rotatably within the first and second cylinders for activating the driving unit.

### CROSS-REFERENCE TO RELATED APPLICATION

This application claims priority of Taiwanese Application No. 100117366, filed on May 18, 2011.

### BACKGROUND OF THE INVENTION

1. Field of the Invention

This invention relates to an air cylinder, and more particularly to a pneumatic tool having an air cylinder unit.

2. Description of the Related Art

Referring to FIGS. 1 and 2, a pneumatic tool 1 disclosed in Taiwanese Patent No. 287457 includes an outer housing 11, an air cylinder unit 12 disposed in the outer housing 11, and a driving unit 13 disposed in the outer housing 11. The outer housing 11 has a rear section 111 for receiving the air cylinder unit 12, a front section 112 for receiving the driving unit 13 and connected to the rear section 111 along an axis (X), a handle 113 formed on the rear section 111 and adjacent to the rear end of the rear section 111, and an intake passage 114 formed in the handle 113 and in fluid communication with the outside. The air cylinder unit 12 includes an air cylinder 121 disposed within the rear section 111, a rotor 122 disposed within the air cylinder 121 for activating the driving unit 13, an air passage 123 formed in the air cylinder 121 and parallel to the axis (X) for permitting air to flow into the air cylinder 121 therethrough, and an intake channel 124 formed in the air cylinder 121, extending along a direction perpendicular to the axis (X), and in fluid communication with the intake passage 114 and the air passage 123.

When air flows into the air cylinder 121 through the intake passage 114 in the handle 113, the intake channel 124, and the air passage 123, the rotor 122 can be rotated to activate the driving unit 13. However, such an intake flow path suffers from the following drawbacks:

1. Since the intake channel 124 is perpendicular to the air passage 123, a serious pressure drop occurs in the intake flow path.

2. Since the intake channel 124 is perpendicular to the axis (X), the handle 113 have to be connected to the rear section 11 at a position adjacent to the rear end of the rear section 11, and thus cannot be located in proximity to the gravity center of the outer housing. As a result, the front end of the pneumatic tool 1 is apt to decline, so that it is difficult to maintain the balance of the pneumatic tool 1 during use.

### SUMMARY OF THE INVENTION

The object of this invention is to provide a pneumatic tool having an air cylinder unit that can provide a high airflow pressure.

According to an aspect of this invention, there is provided an air cylinder unit adapted for use in a pneumatic tool, the pneumatic tool including a front section, a rear tool section connected to and disposed behind the front section, and a driving unit mounted to the front section for outputting kinetic energy, the rear section including a main body, a handle connected to the main body and adjacent to the front section, and an intake passage in fluid communication with the outside, the air cylinder unit comprising:
a first cylinder adapted to be mounted within the rear section;
a second cylinder connected to the first cylinder along an axis and having a front end adapted to be disposed in proximity to the front section, an extension portion adapted to extend into the handle, and an intake channel inclined with respect to the axis and having an inlet in fluid communication with intake passage, and an outlet in fluid communication with the first cylinder; and
a rotor unit mounted rotatably within the first and second cylinders and adapted for activating the driving unit.

According to another aspect of this invention, there is provided a pneumatic tool comprising:
a front section;
a rear section connected to and disposed behind the front section along an axis and including a main body, a handle connected to the main body and adjacent to the front section, and an intake passage adapted to be in fluid communication with the outside;
a driving unit mounted to the front section for outputting kinetic energy; and
an air cylinder unit including
   a first cylinder mounted within the rear section,
      a second cylinder connected to the first cylinder along an axis and having a front end disposed in proximity to the front section, an extension portion extending into the handle, and an intake channel inclined with respect to the axis and having an inlet in fluid communication with intake passage, and an outlet in fluid communication with the first cylinder, and
a rotor unit mounted rotatably within the first and second cylinders for activating the driving unit.

### BRIEF DESCRIPTION OF THE DRAWINGS

These and other features and advantages of this invention will become apparent in the following detailed description of the preferred embodiments of this invention, with reference to the accompanying drawings, in which:

FIG. 1 is an exploded perspective view of a conventional pneumatic tool disclosed in Taiwanese Patent No. 287457;

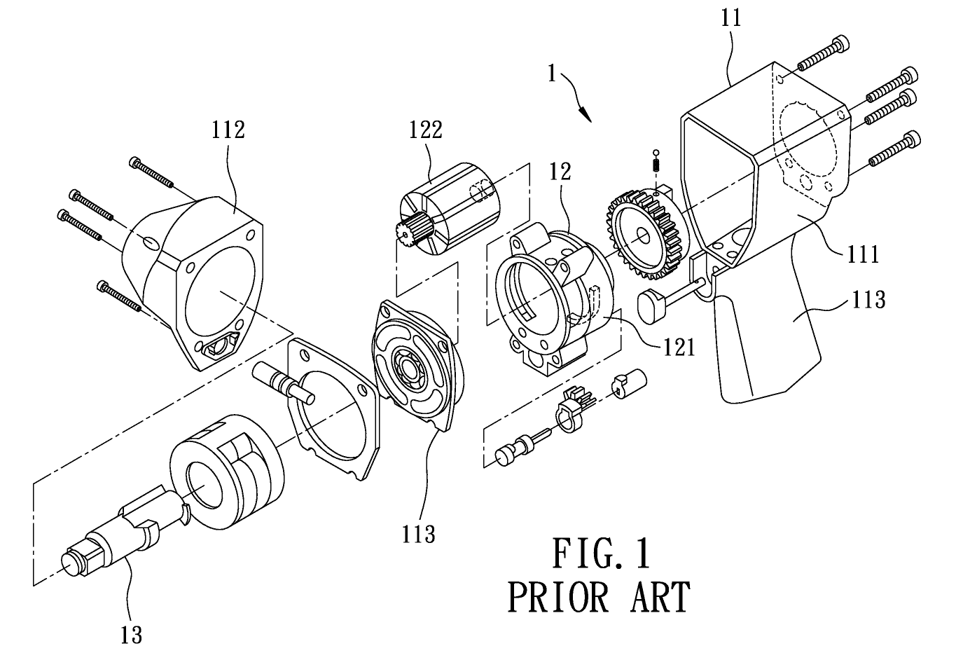

FIG. 2 is a sectional view of the conventional pneumatic tool;

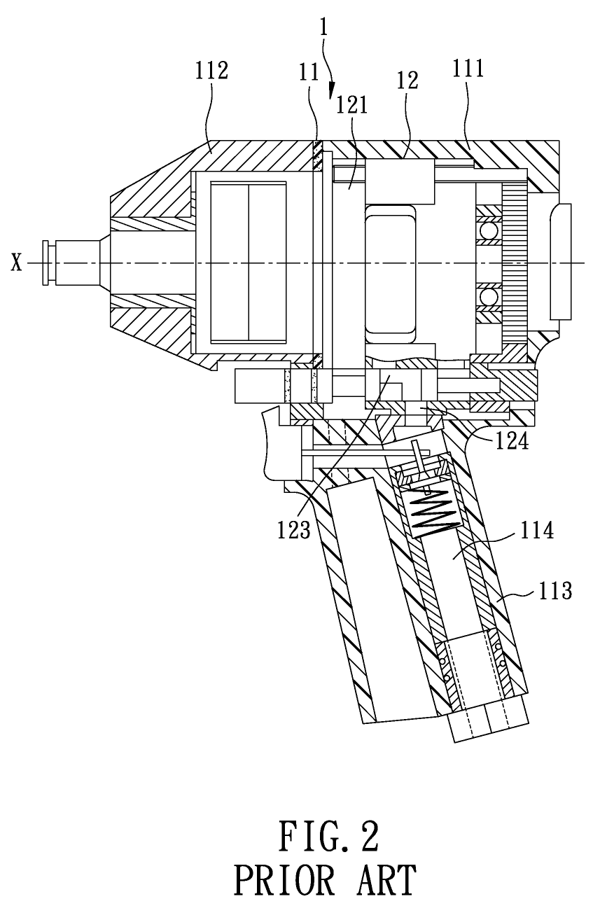

FIG. 3 is an exploded perspective view of the first preferred embodiment of a pneumatic tool according to this invention;

FIG. 4 is a sectional view of the first preferred embodiment;

FIG. 5 is an exploded perspective view of the second preferred embodiment of a pneumatic tool according to this invention; and

FIG. 6 is a sectional view of the second preferred embodiment.

### DETAILED DESCRIPTION OF THE PREFERRED EMBODIMENTS

Before the present invention is described in greater detail in connection with the preferred embodiments, it should be noted that similar elements and structures are designated by like reference numerals throughout the entire disclosure.

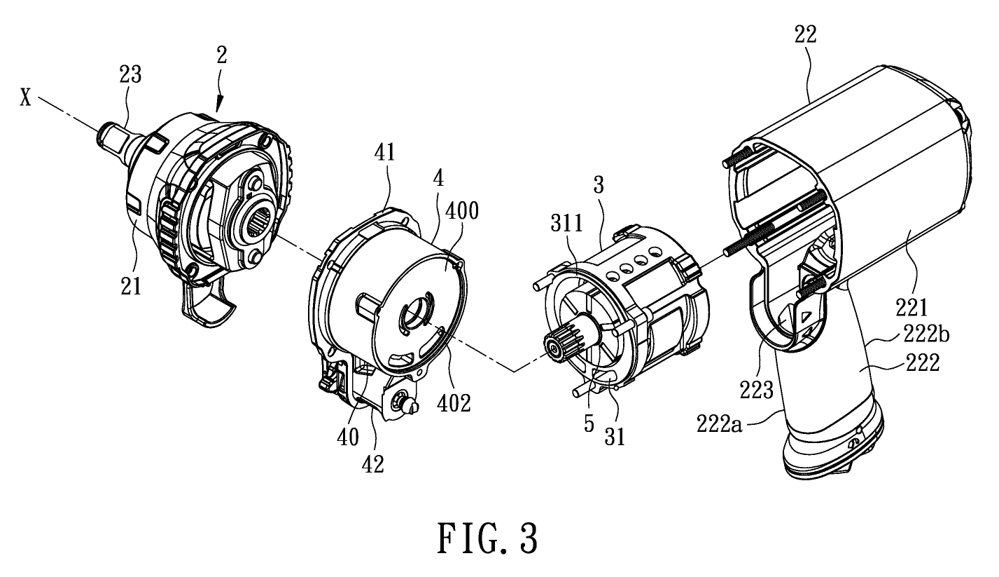

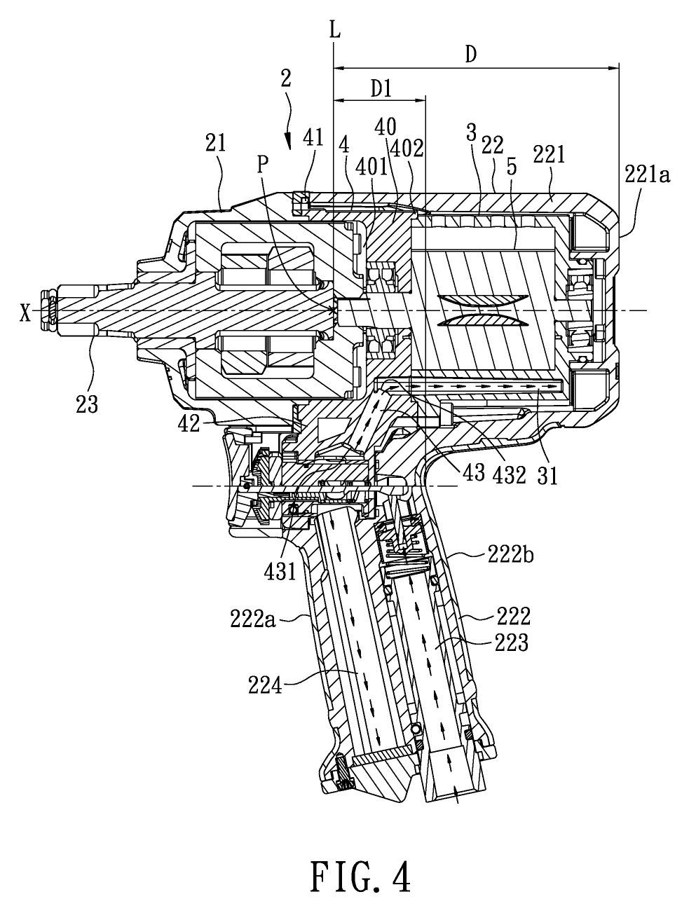

Referring to FIGS. 3 and 4, the first preferred embodiment of a pneumatic tool 2 according to this invention includes a front section 21, a rear section 22 connected to and disposed behind the front section 21 along an axis (X), a driving unit 23 mounted within the front section 21 for outputting kinetic energy, and an air cylinder unit including a first cylinder 3, a second cylinder 4, and a rotor unit 5. The rear section 22 includes a main body 221, a handle 222 connected to the main body 221 and adjacent to the front section 21, an intake passage 223 formed in the handle 222 and in fluid communication with the outside, and an exhaust passage 224. The rear section 22 defines an imaginary gravity-center line (L) perpendicular to the axis (X) and passing through the gravity center (P) of the pneumatic tool 2 and the handle 222. The handle 222 has a front side 222a and a rear side 222b that are parallel to each other. The rear side 222b extends downwardly and rearwardly from the main body 221 of the rear section 22. A minimum distance (D1) between the rear side 222b and the gravity-center line (L) along a direction parallel to the axis (X), that is, the distance (D1) between the top end of the rear side 222b and the gravity-center line (L) along the direction parallel to the axis (X), is 30% to 40% of the distance (D) between the gravity-center line (L) and a rear end 221a of the main body 221 along the direction parallel to the axis (X).

The first cylinder 3 is mounted within the rear section 22, and has an air passage 31 extending parallel to the axis (X).

The second cylinder 4 has a front end disposed in proximity to the front section 21, and includes a cylinder body 40 abutting against and connected to the first cylinder 3 along the axis (X), an outward flange 41 extending radially and outwardly from the front end of the cylinder body 40 and disposed between the front and rear sections 21, 22, an extension portion 42 extending into the handle 22, and an inclined intake channel 43 formed in the extension portion 42 and inclined with respect to the axis (X). The cylinder body 40 has an annular rear end wall 400 cooperating with the front section 21 to define an accommodating chamber 401 therebetween, and an annular axial flange 402 extending rearwardly from an outer periphery of the rear end wall 400 and sleeved on a diameter-reduced front end 311 of the first cylinder 3. The intake channel 43 has an inlet 431 in fluid communication with the intake passage 223, and an outlet 432 in fluid communication with the air passage 31.

The rotor unit 5 is mounted rotatably within the first and second cylinders 3, 4, and is rotatable to activate the driving unit 23.

As such, air flows into the extension portion 42 of the second cylinder 4 through the intake passage 223 in the handle 222, and subsequently into the air passage 31 through the inclined intake channel 43 without turning by a comparatively large angle. Consequently, air can flow smoothly into the air passage 31 in the first cylinder 3 through the outlet 432 of the intake channel 43, and finally into the atmosphere through the exhaust passage 224.

Since the intake channel 43 is inclined, and since the inlet 431 of the intake channel 43 is directed toward the front section 21, the top end of the handle 222 can be disposed in proximity to the gravity center (P) of the pneumatic tool. As compared to the above-mentioned prior art, the position of the top handle 222 is moved forwardly by about 25.4 mm relative to the gravity center (P).

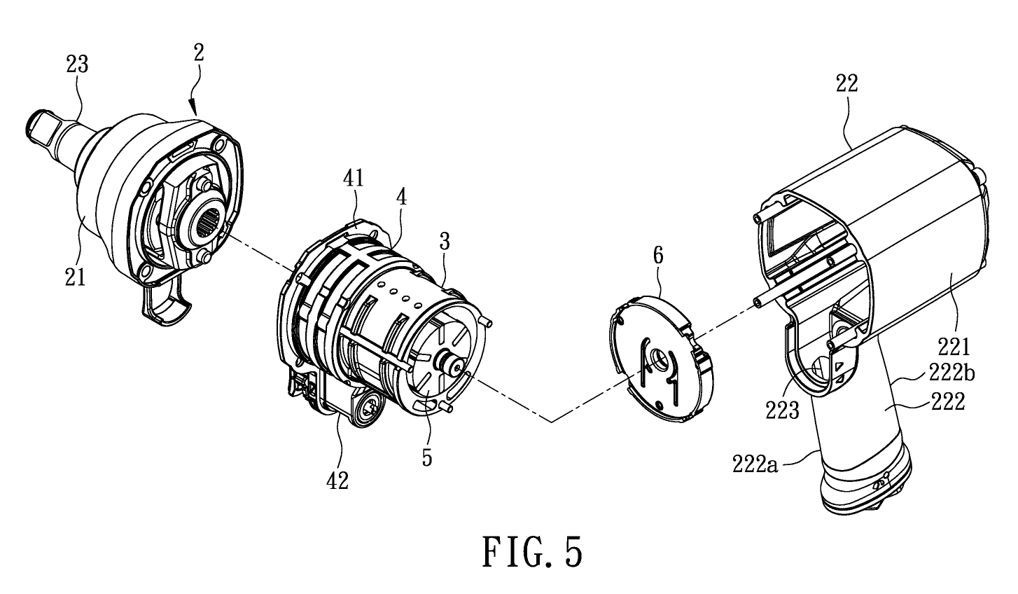

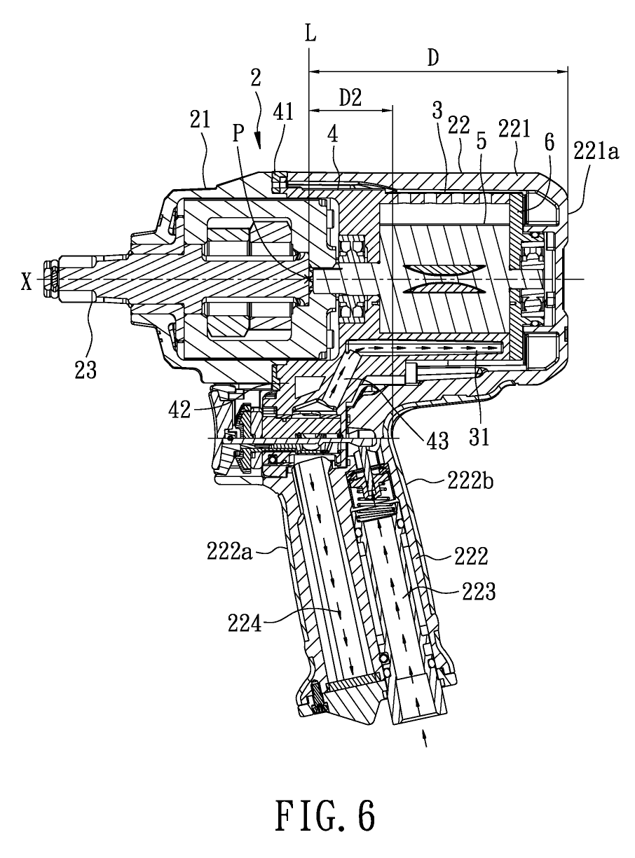

FIGS. 5 and 6 show the second preferred embodiment of a pneumatic tool 2 according to this invention, which differs from the first preferred embodiment in that, the first and second cylinders 3, 4 are formed into one piece, and a rear cylinder cap 6 is added to cover a rear end of an assembly of the first and second cylinders 3, 4. As such, the number of the components is reduced to simplify the structure of the pneumatic tool 2. In this manner, escape of air from junctions between components can also be reduced, thereby promoting the pneumatic driving effect.

In view of the above, the pneumatic tool of this invention has the following advantages:

1. The extension portion 42 extends from the outward flange 41, and is adjacent to the front section 21. In other words, the extension portion 42 is disposed under a rear portion of the driving unit 23 to thereby allow the intake channel 43 to be designed as being inclined. As such, the position of the handle 222 can be changed according to the needs of the user. For example, to maintain the balance of the pneumatic tool 2 and for ergonomic considerations, the handle 222 is positioned such that the force application point of the handle holding force is adjacent to the gravity center of the pneumatic tool 2, thereby facilitating easy and convenient operation of the pneumatic tool 2.

2. Since the intake channel 43 is inclined relative to the air passage 31, pressure drop occurring therebetween is reduced, to provide a high airflow pressure, so that air can flow smoothly into the first cylinder 3 to thereby drive effectively rotation of the rotor unit 5.

With this invention thus explained, it is apparent that numerous modifications and variations can be made without departing from the scope and spirit of this invention. It is therefore intended that this invention be limited only as indicated by the appended claims.

We claim:

1. An air cylinder unit adapted for use in a pneumatic tool, the pneumatic tool including a front section, a rear section connected to and disposed behind the front section, and a driving unit mounted to the front section for outputting kinetic energy, the rear section including a main body, a handle connected to the main body and adjacent to the front section, and an intake passage in fluid communication with the outside, said air cylinder unit comprising:
a first cylinder adapted to be mounted within the rear section;
a second cylinder connected to said first cylinder along an axis and having a front end adapted to be disposed in proximity to the front section, an extension portion adapted to extend into the handle, and an intake channel inclined with respect to said axis and having an inlet in fluid communication with said intake passage, and an outlet in fluid communication with said first cylinder; and
a rotor unit mounted rotatably within said first and second cylinders and adapted for activating the driving unit.

2. The air cylinder unit as claimed in claim 1, wherein said first cylinder has an air passage extending along a direction parallel to said axis and in fluid communication with said outlet of said intake channel for permitting air to flow into said first cylinder therethrough.

3. The air cylinder unit as claimed in claim 1, wherein said second cylinder has a cylinder body abutting against and connected to said first cylinder, and an outward flange extending radially and outwardly from an end of said cylinder body and adapted to be disposed between the front and rear sections, said extension portion extending from said outward flange.

4. The air cylinder unit as claimed in claim 3, wherein said cylinder body has an annular rear end wall adapted to cooperate with the front section to define an accommodating chamber therebetween for receiving the driving unit.

5. The air cylinder unit as claimed in claim 4, wherein said first cylinder has a diameter-reduced front end, and said cylinder body further has an annular axial flange extending rearwardly from an outer periphery of said rear end wall and sleeved on said front end of said first cylinder.

6. The air cylinder unit as claimed in claim 1, wherein said second cylinder and said first cylinder are formed into one piece.

7. A pneumatic tool comprising:
a front section;
a rear section connected to and disposed behind said front section along an axis and including a main body, a handle connected to said main body and adjacent to said front section, and an intake passage adapted to be in fluid communication with the outside;
a driving unit mounted to said front section for outputting kinetic energy; and
an air cylinder unit including
a first cylinder mounted within the rear section,
a second cylinder connected to said first cylinder along said axis and having a front end disposed in proximity to the front section, an extension portion extending into the handle, and an intake channel inclined with respect to said axis and having an inlet in fluid communication with intake passage, and an outlet in fluid communication with said first cylinder, and
a rotor unit mounted rotatably within said first and second cylinders for activating the driving unit.

8. The pneumatic tool as claimed in claim 7, wherein said first cylinder has an air passage extending along a direction parallel to said axis and in fluid communication with said outlet of said intake channel for permitting air to flow into said first cylinder therethrough.

9. The pneumatic tool as claimed in claim 7, wherein said second cylinder has a cylinder body abutting against and connected to said first cylinder, and an outward flange extending radially and outwardly from an end of said cylinder body and disposed between said front and rear sections, said extension portion extending from said outward flange.

10. The pneumatic tool as claimed in claim 9, wherein said cylinder body has an annular rear end wall cooperating with said front section to define an accommodating chamber therebetween for receiving said driving unit.

11. The pneumatic tool as claimed in claim 10, wherein said first cylinder has a diameter-reduced front end, and said cylinder body further has annular axial flange extending rearwardly from an outer periphery of said rear end wall and sleeved on said front end of said first cylinder.

12. The pneumatic tool as claimed in claim 7, wherein said second cylinder and said first cylinder are formed into one piece.

13. The pneumatic tool as claimed in claim 7, wherein said rear section defines an imaginary gravity-center line perpendicular to said axis and passing through a gravity center of said pneumatic tool, said handle having an inclined rear side extending downwardly and rearwardly from said main body of said rear section, a minimum distance between said rear side and said gravity-center line along a direction parallel to said axis being 30% to 40% of a distance between said rear end of said main body and said gravity-center line along the direction parallel to said axis.
